(19) United States
(12) Patent Application Publication
(10) Pub. No.: US 2018/0095455 A1
(43) Pub. Date: Apr. 5, 2018

(54) MAINTENANCE CONDITION SENSING DEVICE

(71) Applicant: FMC Technologies, Inc., Houston, TX (US)

(72) Inventors: Gabriel Silva, Kingwood, TX (US); Rajeev Pillai, Manvel, TX (US); Olufemi Osaloni, Cypress, TX (US)

(21) Appl. No.: 15/283,785

(22) Filed: Oct. 3, 2016

(51) Int. Cl. G05B 23/02

(52) U.S. Cl. CPC G05B 23/0283; G05B 23/0243

(57) ABSTRACT

A method for monitoring a maintenance condition of a component includes coupling a sensing device to the component. The sensing device includes at least one non-intrusive data sensor and an on-board processing complex including a wireless communication device and being coupled to the at least one non-intrusive data sensor. Data from the at least one non-intrusive data sensor is processed in the on-board processing complex using a maintenance model to determine a maintenance condition metric for the component. The maintenance condition metric is transmitted to a remote system using the wireless communication device.

### BACKGROUND

The disclosed subject matter relates generally to hydrocarbon production and, more particularly, to a maintenance condition sensing device including sensors, a communication device, and an embedded processor for coupling to a component defining a flow passage for determining a maintenance condition of the component.

Components used for hydrocarbon exploration requires a routine time-based maintenance schedule to determine compliance. Inspections are commonly performed to assess corrosion, erosion, seal integrity or fatigue issues. However, the correct interval between maintenance depends on process conditions and operator requirements, which are not always readily available. Moreover, inspection tools available for testing these components are expensive and difficult to handle/operate and typically require the parts to be removed from field and tested in a warehouse or laboratory setting. In most cases, the testing involves the use of sophisticated lab equipment operated by certified personnel to accurately perform tests, collect information and analyze the data to determine the operability of the component. The removal of components for testing and analysis is expensive and time consuming. If the maintenance interval is too short, costs increase, while, if the maintenance interval is too long, component degradation may occur and service life and safety may be compromised. In addition, situations occur where the process data is not recorded accurately due to inefficient data logging methodologies and human errors. There are also instances where dangerous events such as pressure surges (spikes) or high shocks above acceptable limits are not captured by traditional data loggers.

This section of this document is intended to introduce various aspects of art that may be related to various aspects of the disclosed subject matter described and/or claimed below. This section provides background information to facilitate a better understanding of the various aspects of the disclosed subject matter. It should be understood that the statements in this section of this document are to be read in this light, and not as admissions of prior art. The disclosed subject matter is directed to overcoming, or at least reducing the effects of, one or more of the problems set forth above.

### SUMMARY

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

One aspect of the disclosed subject matter is seen in a method for monitoring a maintenance condition of a component. The method includes coupling a sensing device to the component. The sensing device includes at least one non-intrusive data sensor and an on-board processing complex including a wireless communication device and being coupled to the at least one non-intrusive data sensor. Data from the at least one non-intrusive data sensor is processed in the on-board processing complex using a maintenance model to determine a maintenance condition metric for the component. The maintenance condition metric is transmitted to a remote system using the wireless communication device.

Another aspect of the disclosed subject matter is seen in a method including coupling a sensing device to a component. The sensing device has a flexible body, at least one non-intrusive data sensor coupled to the flexible body, and an on-board processing complex including a wireless communication device coupled to the at least one non-intrusive data sensor and to the flexible body. Data from the at least one non-intrusive data sensor is processed in the on-board processing complex using a maintenance model to determine a maintenance condition metric for the component. The maintenance condition metric includes a remaining useful life metric. An operational recommendation is generated based on the remaining useful life metric. The operational recommendation is transmitted to a remote system using the wireless communication device.

Yet another aspect of the disclosed subject matter is seen in a device including a flexible body, at least one non-intrusive data sensor coupled to the flexible body, and a processing complex including a wireless communication device coupled to the at least one non-intrusive data sensor and the flexible body. The processing complex is to process data from the at least one non-intrusive data sensor using a maintenance model to determine a maintenance condition metric for a component to which the device is coupled and transmit the maintenance condition metric to a remote system using the wireless communication device.

### BRIEF DESCRIPTION OF THE DRAWINGS

The disclosed subject matter will hereafter be described with reference to the accompanying drawings, wherein like reference numerals denote like elements, and:

FIG. 1 is a simplified diagram of a maintenance warning system, according to some embodiments disclosed herein;

FIG. 2 is a diagram of the maintenance warning system of FIG. 1 prior to installation, according to some embodiments disclosed herein; and

FIG. 3 is a flow diagram of a method for determining a maintenance condition of a component, according to some embodiments disclosed herein.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DESCRIPTION OF EMBODIMENTS

One or more specific embodiments of the disclosed subject matter will be described below. It is specifically intended that the disclosed subject matter not be limited to the embodiments and illustrations contained herein, but include modified forms of those embodiments including portions of the embodiments and combinations of elements of different embodiments as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the disclosed subject matter unless explicitly indicated as being “critical” or “essential.”

The disclosed subject matter will now be described with reference to the attached figures. Various structures, systems and devices are schematically depicted in the drawings for purposes of explanation only and so as to not obscure the disclosed subject matter with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

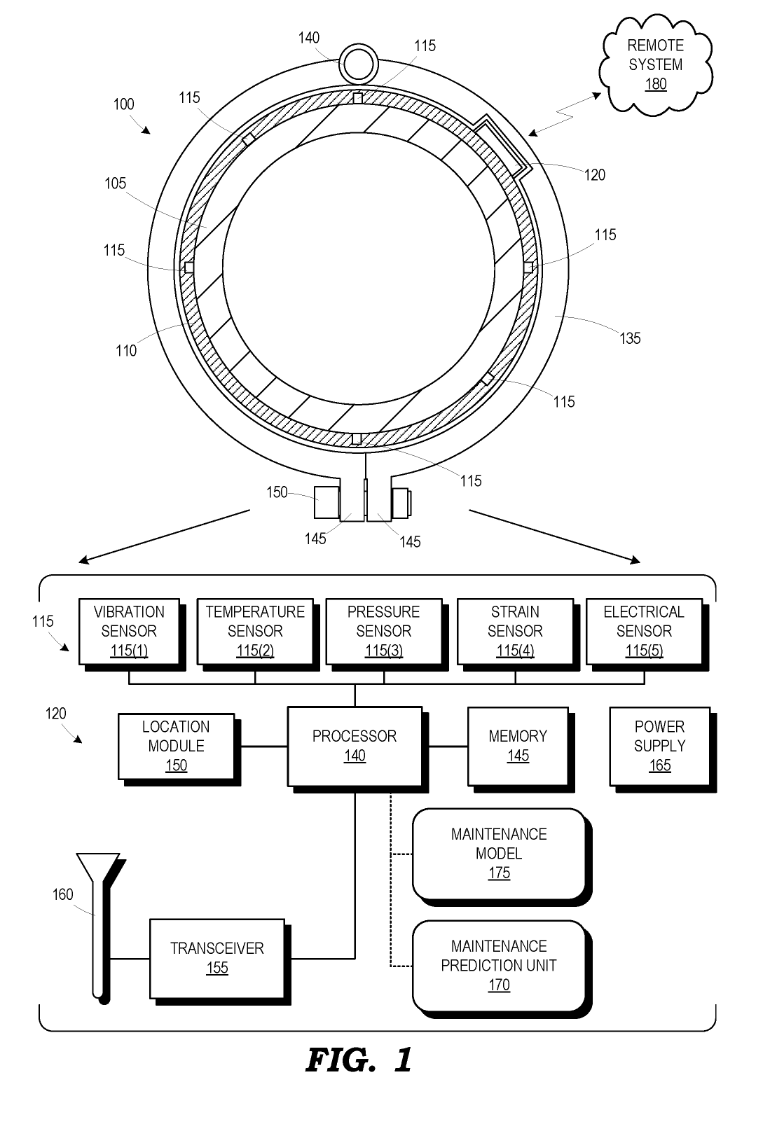

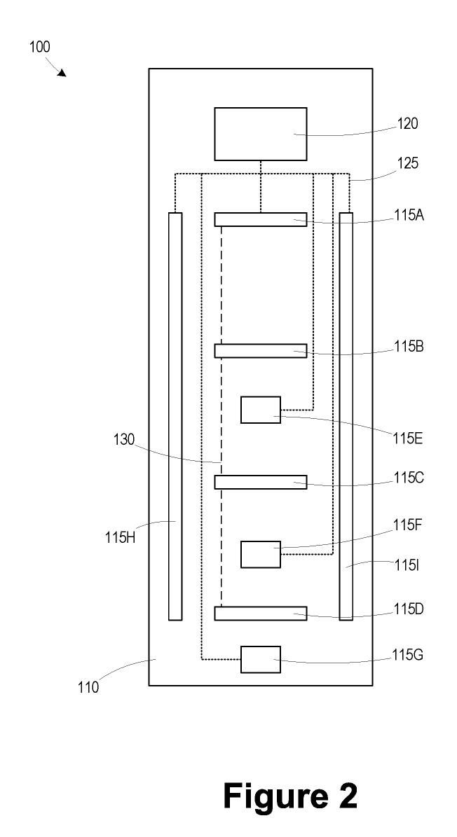

Referring now to the drawings wherein like reference numbers correspond to similar components throughout the several views and, specifically, referring to FIG. 1, the disclosed subject matter shall be described in the context of a maintenance condition sensing device 100 for attachment to a component 105 (e.g., pipe, wellhead, riser, flow line, Christmas tree, pump, manifold, valve, connector, choke, etc.) for monitoring the maintenance condition and process parameters of the component 105. The component 105 may be installed in a surface environment or a subsea environment. FIG. 2 illustrates the maintenance condition sensing device 100 prior to installation on the component 105. In some embodiments, the component 105 is a tubular member. The term tubular does not require that the component has a circular cross-section, but rather that there is generally a wall that creates a pressure boundary relative to an interior cavity (e.g., flow passage).

The maintenance condition sensing device 100 includes a flexible body 110 to which a plurality of sensors 115 (individually enumerated as 115A-115I in FIG. 2) and a processing complex 120 are mounted (e.g., attached to the body 110 or encapsulated by a portion of the body 110). The sensors 115 are connected to the processing complex 120 by lines 125, and one or more sensors 115 (e.g., sensors 115A-115D) may be interconnected by lines 130. The lines 125, 130 may be attached to or embedded in the flexible body 110. The number, type and arrangement of the sensors 115A-115I may vary. The maintenance condition sensing device 100 may be interfaced with the component 105 by wrapping the flexible body 110 around the component 105. In general, the sensors 115 are non-intrusive sensors employed to determine the process and physical conditions of the component 105. The sensors 115H, 115I may be circumferential sensors in that they may wrap around most or all of the circumference of the component 105 when the flexible body 110 is wrapped around the component 105. In some embodiments, the length of the flexible body 110 may be selected so as to wrap around the component 105 one or more times, and the sensors 115 may be arranged to account for the intended interface area.

A housing 135 may be provided to enclose the flexible body 110 and its attachments. The housing 135 may be a clamp type device including a hinge 140 and extending plates 145 that may be engaged with one another using a fastener 150 (e.g., nut and bolt). The housing 135 may seal to the component 105 to isolate the flexible body 110 from the external environment. A protective wrap (not shown) may be provided between the flexible body 110 and the housing 135 and/or over the housing 135 to provide additional protection and/or sealing.

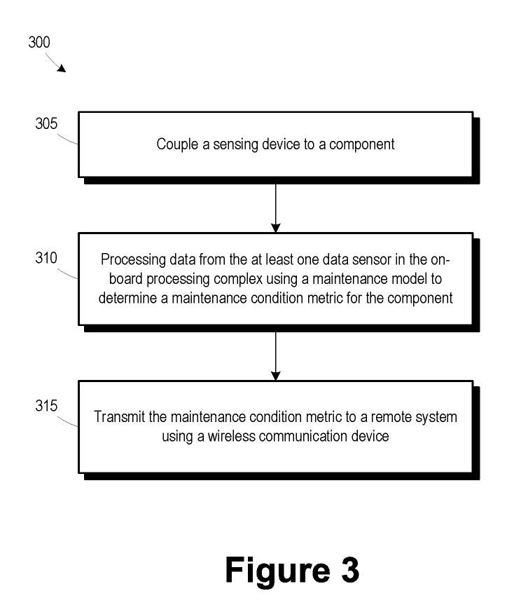

FIG. 1 includes a simplistic block diagram of the processing complex 120. The processing complex 120 includes, among other things, a processor 140, a memory 145, a location module 150 (e.g., GPS module, WiFi RSSI location estimator, gyroscope, compass, etc.), a transceiver 155, an antenna 160, and a power supply 165 (e.g., battery, solar unit, etc.). The plurality of sensors 115 are coupled to the processor 140. The memory 145 may be a volatile memory (e.g., DRAM, SRAM) or a non-volatile memory (e.g., ROM, flash memory, hard disk, etc.). The transceiver 155 transmits and receives signals via the antenna 160, thereby defining a wireless communication device. The transceiver 155 may include one or more radios for communicating according to different radio access technologies, such as cellular, Wi-Fi, Bluetooth®, etc. The processor 140 may execute instructions stored in the memory 145 and store information in the memory 145, such as the results of the executed instructions. The processing complex 120 may implement a maintenance prediction unit 170 that employs the outputs of the sensors 115 in conjunction with a maintenance model 175 to determine a maintenance condition metric for the component 105 and perform portions of a method 300 shown in FIG. 3 and discussed below. The maintenance prediction unit 170 may communicate determined maintenance condition metrics to a remote system 180 via the transceiver 155. Although the sensors 115 are illustrated as being directly connected to the processing complex 120, in some embodiments, one or more of the sensors 115 may connect to the processing complex 120 wirelessly via the transceiver 155 and antenna 160.

Example sensors 115 that may be included in the maintenance condition sensing device 100 include a vibration sensor 115(1), a temperature sensor 115(2), a pressure sensor 115(3), a strain sensor 115(4), an electrical sensor 115(5), (e.g., resistance, voltage, current, electrical field, magnetic field), etc. The sensors 115A-115I illustrated in FIG. 2 may be selected from one or more of the sensors 115(1)-115(5) shown in FIG. 1. In general, the sensors 115 may be optical, electrical, piezoelectric, magnetic, magnetorestrictive, mechanical, etc.

FIG. 3 is a flow diagram of a method 300 for determining a maintenance condition of a component 105, according to some embodiments disclosed herein. In method block 305, the maintenance condition sensing device 100 is coupled to the component 105. In some embodiments, the sensing device includes at least one non-intrusive data sensor 115, and an on-board processing complex 120 including a wireless communication device 155 coupled to the at least one data sensor 115.

In method block 310, data from the data sensor(s) 115 is processed in the on-board processing complex 120 using a maintenance model 175 to determine a maintenance condition metric for the component 105. There are various techniques that the maintenance prediction unit 170 may employ to determine maintenance condition metrics for the component 105. The maintenance prediction unit 170 employs the outputs of the sensors 115 in conjunction with the maintenance model 175 using techniques developed based on finite element analysis (FEA), computational fluid dynamics (CFD), etc., to determine maintenance conditions relevant to the component 105, such as internal pipe pressure, fatigue, crack presence, flow rate, erosion, corrosion, temperature, sediment build-up, etc. Machine learning algorithms may be employed to re-learn, optimize, and adapt to changing process and environmental conditions to build new correlation models in the field.

In one example, strain may be measured based on input from the pressure sensor 115(3) or the strain sensor 115(4). The maintenance model 175 may include a model that linearly correlates strain with pressure if the input from the pressure sensor 115(3) is employed. The measured or derived strain may be employed in the maintenance model 175 to estimate wall thickness using the relationship:

$$\begin{matrix}p = k ( {ɛ}_{θθ} - {ɛ}_{αα} ) & ( 1 ) \\ p = \frac{E {ɛ}_{θθ} ( {b}^{2} - {a}^{2} )}{2 {a}^{2}} & ( 2 ) \\ E = \frac{G ( {ɛ}_{θθ} - {ɛ}_{αα} )}{{ɛ}_{θθ}} , & ( 3 )\end{matrix}$$

where,
ε_{θθ} is the hoop strain;
ε_{αα} is the axial strain;
b is the outer diameter of the pipeline;
a is the inner diameter of the pipeline;
E is the Young's Modulus;
k is the strain constant; and
G is a constant determined by the pipe geometry.

Hence, by monitoring the value of the constant, E, the wall-thickness can be implicitly monitored. Assuming G is constant, the value of E will remain the same as long as the wall-thickness of the pipeline remain the same. However, any change in the material of the pipeline, mostly internal diameter change, will cause the value of E to change indicating the maintenance condition of the pipeline.

The maintenance model 175 may also include a model that correlates vibration frequency to flow rate. The flow rate may be used to track the duty cycle of the component 105 to estimate the erosion effects of the duty cycle on the wall thickness based on knowledge of the process fluid being conducted through the component 105. Hence, for a given design or initial wall thickness, the maintenance prediction unit 170 may monitor the flow conditions (duty cycle—flow rate over time) and estimate a reduction in the wall thickness over time. Hence, wall thickness may be estimated based on strain, duty cycle or both. The computed wall thickness may represent a maintenance condition metric.

In some embodiments, the maintenance model 175 includes a Remaining-Useful-Life (RUL) model that employs the measured and calculated parameters, such as wall thickness, flow rate, duty cycle, vibration, etc., to estimate a RUL metric for the component 105. The component 105 may have an expected design useful life (DUL). The DUL may be established for a new component or for a serviced component, which may differ. The RUL metric may further be examined by evaluating magnetic and acoustic properties of the component to determine residual stress. For example, the magnetic field distribution on pristine components is uniform and aligned by the earth's magnetic field during manufacture. This field distribution becomes disoriented or non-uniform with stress induced grain boundary movements. Monitoring this non-uniformity or change gives insights into fatigue of the material. Similarly, the acoustic wave propagation properties change with microstructure changes within the material.

In some embodiments, the maintenance prediction unit 170 may be employed to determine a maintenance condition of a different component near the component 105 to which the maintenance condition sensing device 100 is mounted. For example, if the maintenance condition sensing device 100 is mounted to a pipe near one or more pumps, the maintenance model 175 may determine a maintenance condition of a particular pump or a maintenance condition of the group of pumps, such as the pumps being out of synch with one another. By monitoring the pump pressure pulses on the component 105 (e.g., flowline), a signature pressure pulse pattern is expected depending on the number of pumps, the type of pump (e.g., Triplex, Quintuplex), and how the pumps are connected. By monitoring the signature, the maintenance prediction unit 170 can determine if the pumps are not performing as expected. Also, if a choke downstream is activated, the maintenance prediction unit 170 can determine the true choke position by determining the pressure in the lines and the flow rate to identify a maintenance condition where the choke is worn out. In another example, each component in the field has a unique vibration frequency. By comparing the normal operating frequencies to malfunction induced operating frequencies, the maintenance prediction unit 170 may determine a location of a fault or a faulty component.

One type of model that may be used to determine a maintenance condition metric is a recursive principal components analysis (RPCA) model. Maintenance condition metrics are calculated by comparing data for all parameters from the sensors and derived parameters generated based on the sensor readings to a model built from known-good data. The model may employ a hierarchy structure where parameters are grouped into related nodes. The sensor nodes are combined to generate higher level nodes. For example, data related to wall thickness (e.g., strain, vibration, flow rate, duty cycle) may be grouped into a higher level node, and nodes associated with the other maintenance condition parameters may be further grouped into yet another higher node, leading up to an overall node that reflects the overall maintenance condition or RUL of the component 105. The nodes may be weighted based on perceived criticality in the system. Hence, a deviation detected on a component deemed important may be elevated based on the assigned weighting. For an RPCA technique, as is well known in the art, a metric may be calculated for every node in the hierarchy, and is a positive number that quantitatively measures how far the value of that node is within or outside 2.8-σ of the expected distribution. An overall combined index may be used to represent the overall maintenance condition of the component 105. The maintenance model 175 may also employ data other than the data from the sensors 115 in determining the intermediate or overall maintenance condition metrics. For example, real time production data and/or historical data may also be employed. The historical data may be employed to identify trends with the component 105.

In some embodiments, the maintenance prediction unit 170 may generate an operational recommendation based on the maintenance condition metric(s). For example, the operational recommendation may be a graded indicator, such as red for reduced RUL, yellow for intermediate RUL, and green for extended RUL. The operational recommendation may also be generated based on lower level maintenance condition metrics, such as estimated wall thickness, duty cycle, etc. The metric(s) contributing to the grade may be provided with the recommendation. The operational recommendation may indicate a deviation from an allowed condition and/or a data trend that predicts an impending deviation, damage or failure, such as a crack or a buildup of sediment in the component 105.

In method block 315, the maintenance prediction unit 170 transmits the operational recommendation and/or the computed maintenance condition metric(s) to the remote system 180 via the transceiver 155 and the antenna 160. Since the maintenance prediction unit 170 receives the sensor data and calculates the maintenance condition metrics on board, the data required to be sent by the transceiver 155 is significantly reduced when compared to a system that transmits sensor data to a remote location for analysis. This approach minimizes data transmission and, thus, power consumption, thereby extending the life of the power supply 165 (e.g., battery).

In some embodiments, the maintenance prediction unit 170 periodically communicates an overall maintenance condition metric, such as RUL, to the remote system 180. The update frequency may vary depending on the particular implementation (e.g., hourly, daily, etc.) If specific alarm conditions are met for one of the maintenance condition metrics, such as vibration, wall thickness, etc., an alert message may be sent immediately allowing corrective action to be taken. The maintenance prediction unit 170 may generate one or more logs of the process conditions encountered by the component 105 based on the received data and the analysis performed to generate the maintenance condition metrics. The maintenance prediction unit 170 may send portions of the log data to the remote system 180 on request or based on the identification of problem conditions.

In some embodiments, the maintenance prediction unit 170 also employs location data to allow tracking of the component 105 or movement of the maintenance condition sensing device 100 (i.e., to a different component). In some embodiments, the maintenance prediction unit 170 tracks its actual geospatial location using GPS data or received signal strength data from a data network. In this manner, the remote system 180 may construct a map that tracks multiple components by location. In addition, the maintenance conditions of components without monitoring hardware may be estimated based on the maintenance condition metrics of nearby monitored components. In some embodiments, the location module 150 may only track local movement indicating that the maintenance condition sensing device 100 has been moved. If the maintenance prediction unit 170 determines that the maintenance condition sensing device 100 has been moved, various model parameters may be reset (e.g., erosion, duty cycle, wall thickness). Self-optimizing fault tolerant (SOFT) algorithms may be employed to re-learn on-board processing algorithms for the specific location.

In some embodiments, certain aspects of the techniques described above may be implemented by one or more processors of a processing system executing software. The method 300 described herein may be implemented by executing software on a computing device, such as the processing complex 120 of FIG. 1, however, such methods are not abstract in that they improve the operation of the component 105. Prior to execution, the software instructions may be transferred from a non-transitory computer readable storage medium to a memory, such as the memory 145 of FIG. 1.

The software may include one or more sets of executable instructions stored or otherwise tangibly embodied on a non-transitory computer readable storage medium. The software can include the instructions and certain data that, when executed by one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

We claim:

1. A method for monitoring a maintenance condition of a component, comprising:
coupling a sensing device to said component, said sensing device including at least one non-intrusive data sensor and an on-board processing complex including a wireless communication device and being coupled to said at least one non-intrusive data sensor;
processing data from said at least one non-intrusive data sensor in said on-board processing complex using a maintenance model to determine a maintenance condition metric for said component; and
transmitting said maintenance condition metric to a remote system using said wireless communication device.

2. The method of claim 1, further comprising:
generating an operational recommendation based on said maintenance condition metric; and
transmitting said operational recommendation to said remote system using said wireless communication device.

3. The method of claim 2, wherein generating said operational recommendation comprises generating a graded indicator of a maintenance condition of said component.

4. The method of claim 1, wherein determining said maintenance condition metric comprises determining a remaining useful life of said component.

5. The method of claim 1, wherein said sensing device comprises a flexible body, said at least one non-intrusive data sensor and said processing complex are coupled to said flexible body, and coupling said sensing device comprises wrapping said flexible body around at least a portion of said component.

6. The method of claim 5, wherein coupling said sensing device further comprises attaching a housing around said flexible body.

7. The method of claim 5, wherein lines are embedded in said flexible body coupling said at least one non-intrusive data sensor to said processing complex.

8. The method of claim 1, wherein said at least one non-intrusive data sensor comprises a strain gauge, and processing data from said at least one non-intrusive data sensor using said maintenance model comprises estimating a wall thickness of said component.

9. The method of claim 1, wherein said at least one non-intrusive data sensor comprises a vibration sensor, and processing data from said at least one non-intrusive data sensor using said maintenance model comprises determining a duty cycle of said component and estimating a wall thickness of said component based on said duty cycle.

10. The method of claim 1, wherein said sensing device comprises a location module, and the method further comprises transmitting location data associated with said sensing device to said remote system.

11. The method of claim 1, further comprising processing data from said at least one non-intrusive data sensor in said on-board processing complex using said maintenance model to determine a maintenance condition metric for an additional component proximate said component.

12. A device comprising:
a flexible body;
at least one non-intrusive data sensor coupled to said flexible body; and
a processing complex including a wireless communication device coupled to said at least one non-intrusive data sensor and said flexible body, wherein said processing complex is to process data from said at least one non-intrusive data sensor using a maintenance model to determine a maintenance condition metric for a component to which said device is coupled and transmit said maintenance condition metric to a remote system using said wireless communication device.

13. The device of claim 12, wherein said processing complex is to generate an operational recommendation based on said maintenance condition metric and transmit said operational recommendation to said remote system using said wireless communication device.

14. The device of claim 12, wherein said processing complex is to generate a log of process conditions experienced by the component and transmit at least a portion of the log to the remote system.

15. The device of claim 13, wherein said operational recommendation comprises a graded indicator of a maintenance condition of said component.

16. The device of claim 12, wherein said maintenance condition metric comprises a remaining useful life of said component.

17. The device of claim 12, further comprising a housing disposed around said flexible body.

18. The device of claim 17, wherein lines are embedded in said flexible body coupling said at least one non-intrusive data sensor to said processing complex.

19. The device of claim 12, wherein said at least one non-intrusive data sensor comprises a strain gauge, and said processing complex is to process data from said at least one non-intrusive data sensor using said maintenance model to estimate a wall thickness of said component.

20. The device of claim 12, wherein said at least one data sensor comprises a vibration sensor, and said processing complex is to process data from said at least one data sensor using said maintenance model to determine a duty cycle of said component and estimate a wall thickness of said component based on said duty cycle.

21. The device of claim 12, further comprising a location module coupled to said flexible body, wherein said processing complex is to receive location data from said location module and transmit said location data to said remote system.

22. The device of claim 12, wherein said processing complex is to process data from said at least one non-intrusive data sensor using said maintenance model to determine a maintenance condition metric for an additional component proximate said component.

23. A method, comprising:
coupling a sensing device to a component, said sensing device having a flexible body, at least one non-intrusive data sensor coupled to said flexible body, and an on-board processing complex including a wireless communication device coupled to said at least one non-intrusive data sensor and to said flexible body;
processing data from said at least one non-intrusive data sensor in said on-board processing complex using a maintenance model to determine a maintenance condition metric for said component, said maintenance condition metric including a remaining useful life metric;
generating an operational recommendation based on said remaining useful life metric; and
transmitting said operational recommendation to a remote system using said wireless communication device.
